(19) United States
(12) Patent Application Publication
(10) Pub. No.: US 2022/0304509 A1
(43) Pub. Date: Sep. 29, 2022

(54) Barbecue Grill Griddle Mat and Methods of Making and Using the Same

(71) Applicant: Grydlmat, LLC, Lindenhurst, IL (US)

(72) Inventor: Jay Jenison, Lindenhurst, IL (US)

(21) Appl. No.: 17/697,096

(22) Filed: Mar. 17, 2022

Related U.S. Application Data
(60) Provisional application No. 63/166,486, filed on Mar. 26, 2021.

(51) Int. Cl. A47J 37/07

(52) U.S. Cl. CPC A47J 37/0786; A47J 37/067

(57) ABSTRACT

A barbecue grill griddle mat is made from a food safe high strength silicone material having at least one side comprising a gloss finish. The griddle mat may further comprise one or more ridges for containing moisture, debris, and other like damaging material on a top surface of the griddle mat, and for acting as indicia for guiding a user in cutting the griddle mat to fit a plurality of barbecue grill griddle surfaces. The gloss finish is utilized in contact with the grill griddle surface, thereby sealing against the same to protect the griddle surface from moisture, oxidation, pests, debris, and other like material or conditions. Methods of making and using the same are further provided.

### CROSS-REFERENCE TO RELATED APPLICATIONS

The present invention claims priority to U.S. Prov. Pat. App. No. 63/166,486, titled “Barbecue Grill Griddle Mat and Methods of Making and Using the Same,” filed Mar. 26, 2021, which is incorporated herein by reference in its entirety.

### TECHNICAL FIELD

The present invention relates to a barbecue grill griddle mat. Specifically, the griddle mat is preferably made from a food safe high strength silicone material having at least one side comprising a gloss finish. The griddle mat may further comprise one or more ridges for containing moisture, debris, and other like damaging material on a top surface of the griddle mat, and for acting as indicia for guiding a user in cutting the griddle mat to fit a plurality of barbecue grill griddle surfaces. The gloss finish is utilized in contact with the grill griddle surface, thereby sealing against the same to protect the griddle surface from moisture, oxidation, pests, debris, and other like materials or conditions. Methods of making and using the same are further provided.

### BACKGROUND

A griddle is a cooking device consisting of a broad flat surface heated by gas, electricity, wood, or coal, with both residential and commercial applications. In industrialized countries, a griddle is most commonly a flat metal plate. A residential griddle is typically composed of chrome steel, aluminum, cast iron, or carbon steel. Most commercial grade griddles are made from A36 steel, though some are stainless steel or composites of stainless and aluminum. Many griddles are now coated with non-stick Teflon® coatings.

Almost all residential and commercial griddles are heated directly or indirectly by flame or electrical elements. Gas griddles are by far most common. Indeed, it is becoming more common for outside barbecue grills to be made with or include griddle surfaces made of metal, heated by propane gas.

Gas griddles are popular to cook on because they generally provide a cooking surface that provides even and easy cooking of food that is easy to clean without the food, grease, juices, or other like material falling through cooking grates, which may occur on a normal barbecue grill. Thus, a barbecue grill griddle surface may provide an ideal cooking surface for easily controlled cooking in an owner's backyard.

Outdoor barbecue grill griddle surfaces may suffer from the environment in which it is used and stored. Typically, barbecue grill griddles are kept outside, often uncovered, where rain, wind, snow, sun, and other environmental factors, as well as naturally occurring elements such as leaves, sticks, and other like material may cause damage. Oxidation (i.e., rust) can occur on the metal surface, especially due to its exposure to moisture. Likewise, pests such as insects, rodents, and other like creatures can make homes within barbecue grills and on griddle surfaces, spreading waste and disease.

A need, therefore, exists for an improved protective surface for a barbecue grill griddle. Specifically, a need exists for an improved protective surface for a barbecue grill griddle that prevents or at least minimizes exposure of the griddle surface to environmental factors, such as rain, snow, wind, sun, and other like environmental factors. More specifically, a need exists for an improved protective surface for a barbecue grill griddle that prevents or at least minimizes contact of pests, such as insects, rodents, or other like creatures with barbecue grill griddle surfaces.

Moreover, a need exists for a barbecue grill griddle mat that may be easily moved on and off a griddle surface. In addition, a need exists for a barbecue grill griddle mat that has a surface that effectively seals against the griddle surface, preventing or at least minimizing contact by the aforementioned environmental conditions or creatures. Further, a need exists for a barbecue grill griddle mat that is easily sized and shaped to be used on a plurality of variously shaped barbecue grill griddle surfaces.

### SUMMARY OF THE INVENTION

The present invention relates to a barbecue grill griddle mat. Specifically, the griddle mat is made from a food safe high strength silicone material having at least one side comprising a gloss finish. The griddle mat may further comprise one or more ridges for containing moisture, debris, and other like damaging material on a top surface of the griddle mat, and for acting as indicia for guiding a user in cutting the griddle mat to fit a plurality of barbecue grill griddle surfaces. The gloss finish is utilized in contact with the grill griddle surface, thereby sealing against the same to protect the griddle surface from moisture, oxidation, pests, debris, and other like material or conditions. Methods of making and using the same are further provided.

To this end, in an embodiment of the present invention, a cover for use on a griddle surface is provided. The cover comprises: a mat made from an elastomeric material having a first surface and a second surface opposing the first surface, the first surface having a gloss finish forming a glossy surface, wherein the mat is configured to be placed on a griddle surface having the glossy surface in contact with the griddle surface.

In an embodiment, the glossy finish of the first surface has an Ra value of between 0.012 to 0.025 μm

In an embodiment, the elastomeric material is silicone.

In an embodiment, the elastomeric material has a durometer Shore A hardness measured between about 50 and about 70.

In an embodiment, the mat is configured for use on a grill griddle surface.

In an embodiment, the cover further comprises: a first raised ridge running around a perimeter of the mat.

In an embodiment, the first raised ridge extends from the second surface of the mat.

In an embodiment, the cover further comprises: a second raised ridge within the perimeter of the mat.

In an embodiment, the second raised ridge extends from the second surface of the mat.

In an embodiment, the cover further comprises: a third raised ridge within the perimeter of the mat.

In an embodiment, the third raised ridge extends from the second surface of the mat.

In an alternate embodiment of the present invention, a method of using a mat on a griddle surface is provided. The method comprises steps of: providing a mat made from an elastomeric material having a first surface and a second surface opposing the first surface, the first surface having a gloss finish forming a glossy surface, wherein the gloss finish of the first surface has an Ra value of between 0.012 to 0.025 μm; and placing the mat on a griddle surface wherein the glossy surface is in contact with the griddle surface.

In an embodiment, the elastomeric material is silicone.

In an embodiment, the elastomeric material has a durometer Shore A hardness measured between about 50 and about 70.

In an embodiment, the mat comprises a first raised ridge extending from the second surface of the mat and running around a perimeter of the mat.

In an embodiment, the mat comprises a first raised ridge extending from the second surface of the mat and running around a perimeter of the mat and a second raised ridge extending from the second surface of the mat and disposed within the perimeter of the mat.

In an embodiment, the method further comprises the step of: cutting the mat adjacent the second raised ridge to form a smaller mat, wherein the smaller mat is sized to fit on a griddle surface having roughly the same surface area as the smaller mat.

In an embodiment, the mat comprises a first raised ridge extending from the second surface of the mat and running around a perimeter of the mat, a second raised ridge extending from the second surface of the mat, and a third raised ridge extending from the second surface of the mat.

In an embodiment, the method further comprises the step of: cutting the mat adjacent the second raised ridge to form a smaller mat, wherein the smaller mat is sized to fit on a griddle surface having roughly the same surface area as the smaller mat.

In an embodiment, the method further comprises the step of: cutting the mat adjacent the third raised ridge to form a smaller mat, wherein the smaller mat is sized to fit on a griddle surface having roughly the same surface area as the smaller mat.

It is, therefore, an advantage and objective of the present invention to provide an improved protective surface for a barbecue grill griddle.

Specifically, it is an advantage and objective of the present invention to provide an improved protective surface for a barbecue grill griddle that prevents or at least minimizes exposure of the griddle surface to environmental factors, such as rain, snow, wind, sun, and other like environmental factors.

More specifically, it is an advantage and objective of the present invention to provide an improved protective surface for a barbecue grill griddle that prevents or at least minimizes contact of pests, such as insects, rodents, or other like creatures with barbecue grill griddle surfaces.

Moreover, it is an advantage and objective of the present invention to provide a barbecue grill griddle mat that may be easily moved on and off a griddle surface.

In addition, it is an advantage and objective of the present invention to provide a barbecue grill griddle mat that has a surface that effectively seals against the griddle surface, preventing or at least minimizing contact by the aforementioned environmental conditions or creatures.

Further, it is an advantage and objective of the present invention to provide a barbecue grill griddle mat that is easily sized and shaped to be used on a plurality of variously shaped barbecue grill griddle surfaces.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an elevated perspective view of a barbecue grill griddle mat in an embodiment of the present invention.

FIG. 2 illustrates a bottom view of a barbecue grill griddle mat in an embodiment of the present invention.

FIG. 3 illustrates a cross-sectional view along lines M-M of a barbecue grill griddle mat in an embodiment of the present invention.

FIG. 4 illustrates a close-up view of section N of FIG. 3 of a barbecue grill griddle mat in an embodiment of the present invention.

FIG. 5 illustrates top views of a barbecue grill griddle mat in various trim configuration in an embodiment of the present invention.

FIG. 6 illustrates a perspective view of a barbecue grill griddle mat disposed on a top surface of a barbecue grill griddle in an embodiment of the present invention.

### DETAILED DESCRIPTION OF THE PRESENTLY PREFERRED EMBODIMENTS

The present invention relates to a barbecue grill griddle mat. Specifically, the griddle mat is made from a food safe high strength silicone material having at least one side comprising a gloss finish. The griddle mat may further comprise one or more ridges for containing moisture, debris, and other like damaging material on a top surface of the griddle mat, and for acting as indicia for guiding a user in cutting the griddle mat to fit a plurality of barbecue grill griddle surfaces. The gloss finish is utilized in contact with the grill griddle surface, thereby sealing against the same to protect the griddle surface from moisture, oxidation, pests, debris, and other like material or conditions. Methods of making and using the same are further provided.

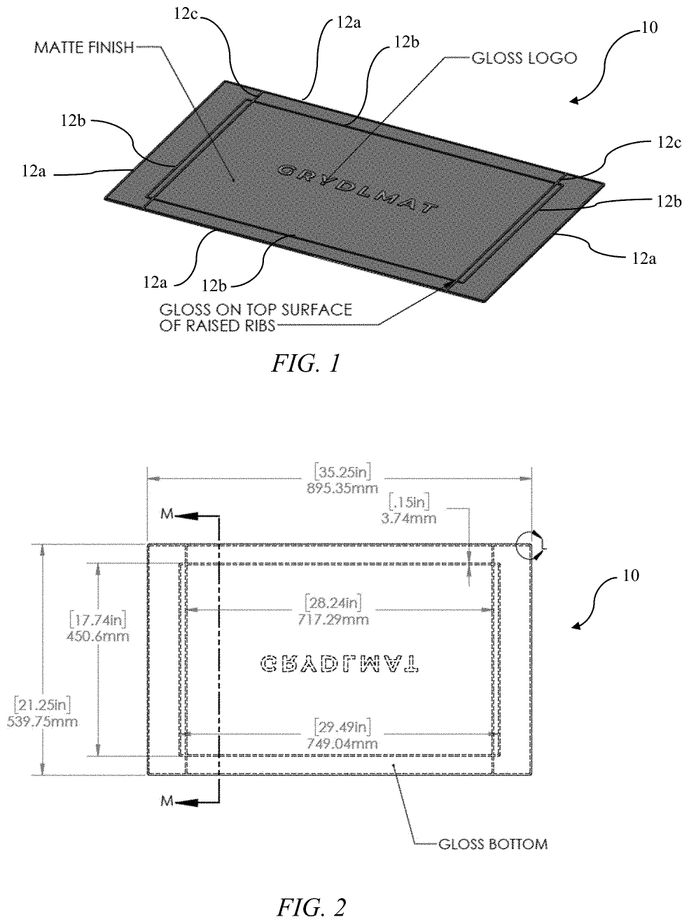

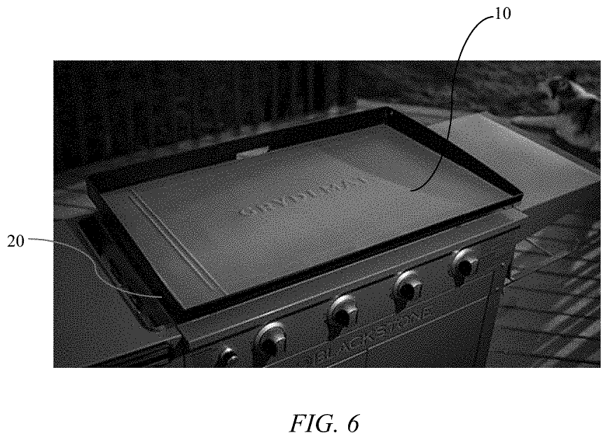

Referring now to the figures, FIG. 1 illustrates a raised perspective view of a barbecue grill griddle mat 10 in an embodiment of the present invention. Although the griddle mat disclosed herein is particularly configured to be used on barbecue grill griddles, as illustrated in FIG. 6, typically used and stored outdoors, it should be noted that the griddle mat 10 disclosed herein may be utilized on any griddle surface and should not be limited as described herein.

The griddle mat 10 may be made form a flexible elastomeric material, preferably a food safe and high strength silicone material. In a preferred embodiment, the silicone material may have a durometer Shore A hardness measured between about 50 to about 70. Preferably, the thickness of the griddle mat 10 may be about 2.5 mm but may be any thickness and should not be limited as described herein. Certain portions of the griddle mat 10 may have different thicknesses, such as ridges or ribs 12, as described in more detail below.

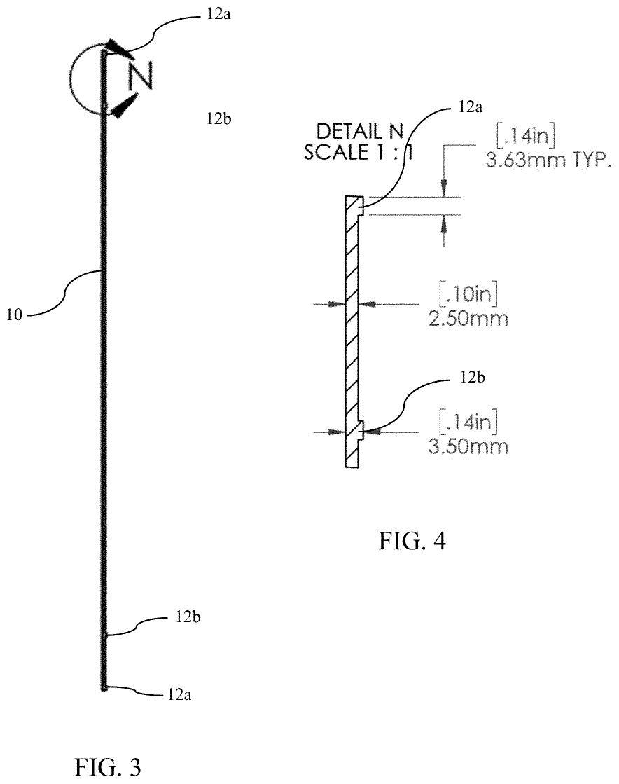

Specifically, a plurality of raised ridges or ribs 12 may extend from a top surface of the griddle mat 10. The raised ridges or ribs 12 may extend about 1.0 mm and preferably higher, such as, preferably, about 14 mm or higher from the surface of the griddle mat as illustrated in FIGS. 3 and 4. The raised ridges or ribs 12 may preferably prevent material, such as pest debris, environmental material, and other like material, from spilling from the top surface of the griddle mat 10. Preferably, the raised ridges or ribs 12 may contain material that may fall onto the top surface of the griddle mat that may otherwise damage the griddle surface. In addition, the raised ridges or ribs 12 may provide structural integrity to the mat 10, aiding in maintaining the mat in a flat configuration, and may also add a pleasing decorative design element.

First raised ridges or ribs 12a may extend around a periphery of the griddle mat 10 and may contain material that falls onto the griddle mat 10. First raised ridges or ribs 12a may be utilized on a full-sized griddle mat 10 that may be used on a relatively large barbecue grill griddle surface, specifically a 36-inch griddle surface.

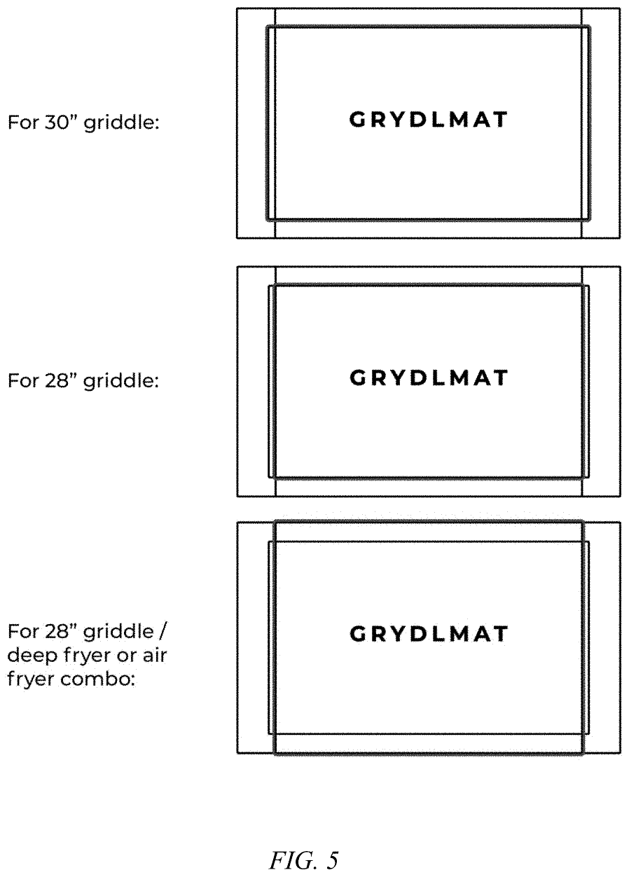

The griddle mat 10 may be reduced in size, specifically by cutting the griddle mat 10 at specific locations to fit smaller-sized barbecue grill griddles. Specifically, second raised ridges or ribs 12b may be positioned within the periphery of the griddle mat 10 and may be used as a guide to cut the griddle mat to fit on a smaller griddle mat 10. Preferably, second raised ridges or ribs 12b may preferably be used as a guide to trim the griddle mat 10 down to fit 30-inch griddle surfaces. Third raised ridges or ribs 12c may be utilized to guide trimming of the griddle mat 10 to fit 28-inch griddle surfaces, specifically if a portion of the third raised ridges or ribs 12c and a portion of the second raised ridges or ribs 12b is used as the guide. Likewise, trimming the griddle mat 10 along only third raised ridges or ribs 12c may allow the trimmed griddle mat 10 to be used with 28-inch griddle surfaces with deep fryer or air fryer combinations. FIG. 5 shows various combinations of trimming along the second and third raised ridges or ribs 12b, 12c to form assorted sizes to be used with assorted sizes of griddle surfaces, with the red line showing various raised ridges or ribs combinations 12b, 12c that may be utilized to trim the griddle mat 10 to fit different sized griddles.

To trim the griddle mat 10 to fit different sized griddles, a cutting tool, such as a blade, scissors, or the like may cut the griddle mat 10 on an outside of the respective raised ridge or rib 12 desired. Thus, when placed upon a griddle surface, the raised ridge or rib may be positioned on an outside periphery of the trimmed griddle mat 10, thereby catching and containing debris that may fall thereon. Although the raised ridges or ribs 12 may be in any configuration for trimming into any shape, and the invention should not be limited as described herein. Likewise, although the griddle mat 10 is described as being useful for particular sizes of griddle surfaces, the griddle mat 10 may be any size or shape and should not be limited as described herein.

The top surface of the griddle mat 10 may have a matte finish, although it may contain any type of finish desired. However, a matte finish may present a hydrophilic surface that may better contain liquid material disposed thereon. In other words, a matte finish may better hold liquid material or other debris in place on the top surface of the griddle mat 10 and contained by the raised ridges or ribs 12.

The bottom surface of the griddle mat 10, however, as illustrated in FIG. 2, may preferably have a gloss finish so that the same may more easily and efficiently seal against a griddle surface when placed thereon, and may resist surface wetting and subsequent particulate penetration into the bottom surface of the griddle mat 10, thereby keeping the surface clean and usable on a griddle surface. Specifically, the bottom surface of the griddle mat may preferably have a gloss finish of SPA Surface Finish A1 or A2 and/or an Ra value of between about 0.012 and about 0.025 μm. More preferably, the bottom surface of the griddle mat may have a gloss finish Ra value of between about 0.015 and about 0.020 μm. Of course, as technology improves, a better gloss finish may be utilized and the present invention should not be limited as described herein. As noted above, the gloss finish more effectively seals the bottom surface of the griddle mat 10 to the griddle surface, thereby protecting the griddle surface from the afore-mentioned environmental and pest material. The gloss finish may effectively reduce friction on the surface thereof, reducing peaks and troughs in the griddle mat 10 surface, which may otherwise grab and hold dust, debris, and water without the gloss surface.

In use, the griddle mat 10 may be used as fully sized or may be trimmed down to fit a smaller size barbecue grill griddle surface as described above. After a griddle surface is cooled and cleaned, the griddle mat 10 maybe placed with the bottom or gloss side down on the griddle surface and kept on the griddle surface during periods of non-use and/or storage. Preferably, a light coat of an oil, specifically a food grade oil, may be coated onto the griddle surface prior to placement of the griddle mat 10 thereon, thereby aiding in sealing the griddle mat 10 to the surface of the griddle and protecting the same from oxidation due to water contact, or dust, pest debris, or other like damaging material. Of course, before heating the griddle surface, the griddle mat 10 should be removed from the griddle surface.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A cover for use on a griddle surface comprising:
a mat made from an elastomeric material having a first surface and a second surface opposing the first surface, the first surface having a gloss finish forming a glossy surface, wherein the mat is configured to be placed on a griddle surface having the glossy surface in contact with the griddle surface.

2. The cover of claim 1 wherein the glossy finish of the first surface has an Ra value of between 0.012 to 0.025 μm

3. The cover of claim 1 wherein the elastomeric material is silicone.

4. The cover of claim 1 wherein the elastomeric material has a durometer Shore A hardness measured between about 50 and about 70.

5. The cover of claim 1 wherein the mat is configured for use on a grill griddle surface.

6. The cover of claim 1 further comprising:
a first raised ridge running around a perimeter of the mat.

7. The cover of claim 6 wherein the first raised ridge extends from the second surface of the mat.

8. The cover of claim 6 further comprising:
a second raised ridge within the perimeter of the mat.

9. The cover of claim 8 wherein the second raised ridge extends from the second surface of the mat.

10. The cover of claim 8 further comprising:
a third raised ridge within the perimeter of the mat.

11. The cover of claim 10 wherein the third raised ridge extends from the second surface of the mat.

12. A method of using a mat on a griddle surface comprising steps of:
providing a mat made from an elastomeric material having a first surface and a second surface opposing the first surface, the first surface having a gloss finish forming a glossy surface, wherein the gloss finish of the first surface has an Ra value of between 0.012 to 0.025 μm; and
placing the mat on a griddle surface wherein the glossy surface is in contact with the griddle surface.

13. The method of claim 12 wherein the elastomeric material is silicone.

14. The method of claim 12 wherein the elastomeric material has a durometer Shore A hardness measured between about 50 and about 70.

15. The method of claim 12 wherein the mat comprises a first raised ridge extending from the second surface of the mat and running around a perimeter of the mat.

16. The method of claim 12 wherein the mat comprises a first raised ridge extending from the second surface of the mat and running around a perimeter of the mat and a second raised ridge extending from the second surface of the mat and disposed within the perimeter of the mat.

17. The method of claim 16 further comprising the step of:
cutting the mat adjacent the second raised ridge to form a smaller mat, wherein the smaller mat is sized to fit on a griddle surface having roughly the same surface area as the smaller mat.

18. The method of claim 12 wherein the mat comprises a first raised ridge extending from the second surface of the mat and running around a perimeter of the mat, a second raised ridge extending from the second surface of the mat, and a third raised ridge extending from the second surface of the mat.

19. The method of claim 18 further comprising the step of:
cutting the mat adjacent the second raised ridge to form a smaller mat, wherein the smaller mat is sized to fit on a griddle surface having roughly the same surface area as the smaller mat.

20. The method of claim 18 further comprising the step of:
cutting the mat adjacent the third raised ridge to form a smaller mat, wherein the smaller mat is sized to fit on a griddle surface having roughly the same surface area as the smaller mat.
